(19) United States
(12) Patent Application Publication
(10) Pub. No.: US 2026/0213582 A1
(43) Pub. Date: Jul. 23, 2026

(54) POWER SUPPLY DEVICE, POWER RECEIVING DEVICE, CHARGING SYSTEM, AND CHARGING CONTROL METHOD

(71) Applicant: Anker Innovations Technology Co., Ltd., Changsha (CN)

(72) Inventors: Jin Qi, Shenzen (CN); Huixing Zhu, Shenzen (CN)

(21) Appl. No.: 19/464,001

(22) Filed: Jan. 29, 2026

Related U.S. Application Data
(63) Continuation of application No. PCT/CN2024/107272, filed on Jul. 24, 2024.

(30) Foreign Application Priority Data
Jul. 30, 2023 (CN) 202310944858.2

(51) Int. Cl. H02J 50/30; H02J 50/80; H04B 10/80

(52) U.S. Cl. CPC H02J 50/30; H02J 50/80; H04B 10/807

(57) ABSTRACT

The present application provides a power supply device, a power receiving device, a charging system, and a charging control method. The power supply device comprises a power supply controller, a power supply optocoupler circuit, and a power supply connector. The power supply optocoupler circuit is connected to the power supply controller. The power supply connector comprises a terminal connected to the power supply optocoupler circuit.

### CROSS-REFERENCE TO RELATED APPLICATIONS

The present application is a continuation application of PCT/CN2024/107272, filed on Jul. 30, 2024, which claims all the benefits of the Chinese patent application No. CN202310944858.2, filed on Jul. 30, 2023 before the China National Intellectual Property Administration of the People's Republic of China, entitled “Power Supply Device, Power Receiving Device, Charging System, and Charging Control Method”, each of which is explicitly incorporated herein by reference in its entirety.

### FIELD

The present application relates to the technical field of charging devices, specifically to a power supply device, a power receiving device, a charging system, and a charging control method.

### BACKGROUND

In related technical fields, a charging system includes a power supply device and a battery that can be connected to the power supply device. The power supply device can supply power to the battery through a power supply side connector, and both the power supply device and the battery have power supply ports that can be used to independently supply power to electrical devices.

When the power supply device is accurately connected to a power receiving side connector of the power supply device through the power supply side connector, the power supply device can charge the battery. However, misalignment between the power supply side connector and the power receiving side connector, or the presence of interference signals, can affect the circuit formed by the power supply side connector and the power receiving side connector.

### SUMMARY

The present application provides a power supply device, a power receiving device, a charging system, and a charging control method. A power supply side optocoupler circuit may be connected to a power supply side controller and a power supply side signal sending terminal in a form of photoelectric isolation, to prevent static electricity or peak voltage from entering the power supply side controller from the power supply side signal sending terminal, thereby reducing the probability of damage to the power supply side controller.

An example of the present application provides a power supply device, including a power supply side controller, a power supply side optocoupler circuit, and a power supply side connector. The power supply side optocoupler circuit is connected to the power supply side controller. The power supply side connector has a power supply side signal sending terminal connected to the power supply side optocoupler circuit. The power supply side controller is configured to control the power supply side signal sending terminal to send one or more power supply side communication signals via the power supply side optocoupler circuit, so as to communicate with a power receiving device.

Based on the above example, the power supply side optocoupler circuit is connected to the power supply side controller and the power supply side signal sending terminal in a form of photoelectric isolation, to prevent static electricity or peak voltage from entering the power supply side controller from the power supply side signal sending terminal, thereby reducing the probability of damage to the power supply side controller, enabling the power supply side controller to have a longer service life, and further enabling the power supply device to have a longer service life.

An example of the present application further provides a power receiving device, including a power receiving side controller, a power receiving side optocoupler circuit, and a power receiving side connector. The power receiving side optocoupler circuit is connected to the power receiving side controller. The power receiving side connector has a power receiving side signal sending terminal connected to the power receiving side optocoupler circuit. The power receiving side controller controls the power receiving side signal sending terminal to send power receiving side communication signals via the power receiving side optocoupler circuit, so as to communicate with a power supply device.

Based on the above example, the power receiving side optocoupler circuit is connected to the power receiving side controller and the power receiving side signal sending terminal in a form of photoelectric isolation, to prevent static electricity or peak voltage from entering the power receiving side controller from the power receiving side signal sending terminal, thereby reducing the probability of damage to the power receiving side controller, enabling the power receiving side controller to have a longer service life, and further enabling the power receiving device to have a longer service life.

An example of the present application further provides a charging system, including a power supply device and a power receiving device. The power supply device further includes a charging circuit, and the charging circuit is connected to the power supply side connector and the power supply side controller. A power supply output terminal is configured to be connected to a power receiving input terminal of the power receiving side connector. The power receiving side connector can be connected to the power supply side connector. After the communication between the power supply device and the power receiving device is established, the charging circuit charges the power receiving device.

Based on the above example, the power supply device is connected to the power receiving device. The power supply device is configured to send power supply side communication signals to the power receiving device via the power supply side signal sending terminal, and determine, after receiving power receiving side communication signals fed back by the power receiving device based on the power supply side communication signals, that the power supply side connector is correspondingly connected to the power receiving side connector. The power supply side controller of the power supply device is configured to control the charging circuit to work, so that the charging circuit charges the power receiving device via the power supply output terminal, to prevent the power supply output terminal from being connected in a charged state to a non-power receiving input terminal of the power receiving side connector, thereby reducing the probability of damage to other ports of the power receiving side connector, enabling the power receiving side connector to have a longer service life, and further enabling the power receiving device to have a longer service life.

The power supply side optocoupler circuit of the power supply device and the power receiving side optocoupler circuit of the power receiving device can reduce the probability of communication interference between the power supply device and the power receiving device, thereby improving the stability of communication between the power supply device and the power receiving device, and further improving the accuracy of signal interaction between the power supply device and the power receiving device.

An example of the present application further provides a charging control method, applied to a power supply device, the charging control method including: controlling a power supply side signal sending terminal via a power supply side optocoupler circuit to send power supply side communication signals; and after receiving power receiving side communication signals, controlling a charging circuit to charge a power receiving device, where the power receiving side communication signals are generated by the power receiving device based on the power supply side communication signals and fed back by a power receiving side signal sending terminal controlled by a power receiving side optocoupler circuit.

An example of the present application further provides a charging control method, applied to a power receiving device, the charging control method including: detecting power supply side communication signals, where the power supply side communication signals are sent by a power supply device; and upon receiving the power supply side communication signals, controlling, by a power receiving side optocoupler circuit, a power receiving side signal sending terminal to feedback power receiving side communication signals to the power supply device, so that the charging circuit charges the power receiving device.

In the power supply device of the present application, the power supply side optocoupler circuit may be connected to the power supply side controller and the power supply side signal sending terminal in a form of photoelectric isolation, to prevent static electricity or peak voltage from entering the power supply side controller from the power supply side signal sending terminal, thereby reducing the probability of damage to the power supply side controller, enabling the power supply side controller to have a longer service life, and further enabling the power supply device to have a longer service life.

### BRIEF DESCRIPTION OF THE DRAWINGS

To describe the technical solutions in the present application or in the prior art more clearly, the following briefly introduces the accompanying drawings required for describing the examples. Apparently, the drawings in the following description show merely some examples of the present application, and those skilled in the art can derive other drawings from these drawings without any creative efforts.

FIG. 1 is a framework structure diagram of a charging system in an example of the present application;

FIG. 2 is a circuit structure diagram of a charging system in an example of the present application;

FIG. 3 is a circuit structure diagram of a charging system in another example of the present application;

FIG. 4 is a circuit structure diagram of a charging system in another example of the present application;

FIG. 5 is a flowchart of a charging control method in an example of the present application; and

FIG. 6 is a flowchart of a charging control method in another example of the present application.

Description of Reference Numerals: 1. charging system; 11. power supply device; 111. power supply side connector; 111A. power supply side signal sending terminal; 111B. power supply side signal receiving terminal; 112. power supply side optocoupler circuit; 1121. first primary circuit; 1122. first secondary circuit; 113. power supply side communication circuit; 114. charging circuit; 1141. power control module; 115. first magnet; 12. power receiving device; 121. power receiving side connector; 121A. power receiving side signal sending terminal; 121B. power receiving side signal receiving terminal; 122. power receiving side optocoupler circuit; 1221. second primary circuit; 1222. second secondary circuit; 123. power receiving side communication circuit; 124. second magnet; OC1. first optocoupler; OC2. second optocoupler; U1. power supply side controller; U2. power receiving side controller; D1. first light-emitting element; D2. second light-emitting element; K1. first photosensitive element; K2. second photosensitive element; Q1. first switching element; Q2. second switching element; Q3. third switching element; Q4. fourth switching element; Q5. fifth switching element; Q6. sixth switching element; R1. first resistor; R2. second resistor; R3. third resistor; R4. fourth resistor; R5. fifth resistor; R6. sixth resistor; R7. seventh resistor; R8. eighth resistor; R9. ninth resistor; R10. tenth resistor; R11. eleventh resistor; R12. twelfth resistor; R13. thirteenth resistor; R14. fourteenth resistor; C1. first capacitor.

### DETAILED DESCRIPTION

In order to make the objectives, technical solutions, and advantages of the present application clearer, the present application will be further described in detail below in conjunction with the accompanying drawings and examples. It should be understood that the specific examples described herein are merely used for explaining the present application, but not for limiting the present application.

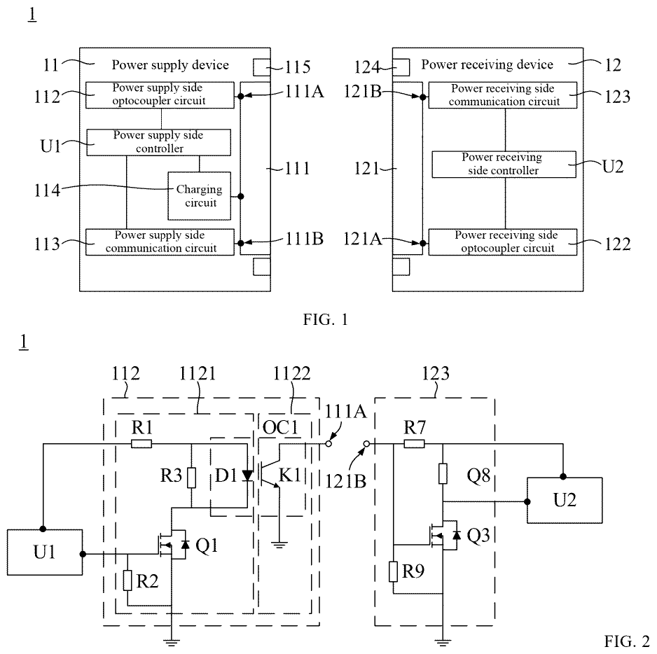

As shown in FIG. 1, an example of the present application provides a charging system 1, including a power supply device 11 and a power receiving device 12.

The power supply device 11 can be connected to a mains supply. The power supply device 11 has a power supply port (not shown), and can supply power to electrical devices via the mains supply. The electrical devices include, but are not limited to, mobile phones, tablets, smart watches, and portable power sources. The power supply port includes at least one of a USB interface, a Micro USB interface, a USB Type-C interface, or a Lightning interface. The power supply device 11 has a power supply side connector 111.

The power receiving device 12 can be connected to the power supply device 11, so that the power supply device 11 can supply power to the power receiving device 12. The power receiving device 12 may be an electrical device. The power receiving device 12 includes a power receiving side connector 121. The power receiving side connector 121 can be connected to the power supply side connector 111, so that the power supply device 11 supplies power to the electrical device 12.

The power supply side connector 111 and the power receiving side connector 121 are connectors that can be used together. For example, the power supply side connector 111 and the power receiving side connector 121 may be at least one type of spring pin connectors, USB connectors, Micro USB connectors, USB Type-C connectors, or Lightning connectors. In an example of the present application, the power supply side connector 111 is a spring pin connector, and the power receiving side connector 121 is a contact connector. In other examples, the power supply side connector 111 and the power receiving side connector 121 may be a plug and a socket that are used in pair.

As shown in FIG. 1, in a specific example, the power supply device 11 includes a power supply side controller U1 and a power supply side optocoupler circuit 112, where the power supply side optocoupler circuit 112 is connected to the power supply side controller U1. The power supply side connector 111 has a power supply side signal sending terminal 111A connected to the power supply side optocoupler circuit 112. Correspondingly, the power receiving device 12 includes a power receiving side communication circuit 123, where the power receiving side communication circuit 123 is connected to a power receiving side signal receiving terminal 121B of the power receiving side controller U2. When the power receiving device 12 is connected to the power supply device 11 (e.g., the power supply side connector 121 is correspondingly connected to the power supply side connector 111), the power supply side signal sending terminal 111A is connected to the power receiving side signal receiving terminal 121B, and the power supply side controller U1 may control the power supply side signal sending terminal 111A via the power supply side optocoupler circuit 112 to send power supply side communication signals, thereby achieving communication between the power supply device 11 and the power receiving device 12.

As shown in FIG. 1 and FIG. 2, in a specific example, the power supply side optocoupler circuit 112 includes a first primary circuit 1121 and a first secondary circuit 1122, where the first primary circuit 1121 includes a first light-emitting element D1, and the first light-emitting element D1 is controlled by the power supply side controller U1. The first secondary circuit 1122 includes a first photosensitive element K1, the first photosensitive element K1 corresponds to the first light-emitting element D1, a positive electrode of the first photosensitive element K1 is connected to the power supply side signal sending terminal 111A, and a negative electrode of the first photosensitive element K1 is connected to a ground terminal of the power supply side connector 111. The first light-emitting element D1 and the first photosensitive element K1 form a first optocoupler OC1. There may be no physical connection between the first light-emitting element D1 and the first photosensitive element K1, so that electrical signals on one side of the first photosensitive element K1 may not be transmitted to the other side of the first light-emitting element D1. Therefore, the first optocoupler OC1 is connected to the power supply side controller U1 and the power supply side signal sending terminal 111A in a form of photoelectric isolation, to prevent static electricity or peak voltage from entering the power supply side controller U1 from the power supply side signal sending terminal 111A, thereby reducing the probability of damage to the power supply side controller U1, enabling the power supply side controller U1 to have a longer service life, and further enabling the power supply device 11 to have a longer service life.

The first light-emitting element D1 may be a light-emitting diode, and the first photosensitive element K1 may be at least one of a photodiode, a photosensitive transistor, a photosensitive resistor, or a thyristor. In the present application, the specific forms of the first light-emitting element D1 and the first photosensitive element K1 are not limited.

As shown in FIG. 1 and FIG. 2, in a specific example, the first primary circuit 1121 further includes a first resistor R1 and a first switching element Q1, where a first terminal of the first resistor R1 is connected to a power supply terminal of the power supply side controller U1, and a second terminal of the first resistor R1 is connected to a positive electrode of the first light-emitting element D1. An input terminal of the first switching element Q1 is connected to a negative electrode of the first light-emitting element D1, an output terminal of the first switching element Q1 is grounded, and a controlled terminal of the first switching element Q1 is connected to a signal output terminal of the power supply side controller U1.

After the power supply device 11 is connected to the mains supply, the power supply side signal sending terminal 111A is connected to the power receiving side signal receiving terminal 121B. The signal output terminal of the power supply side controller U1 controls the first primary circuit 1121, so that the first light-emitting element D1 sends a first light signal to the first photosensitive element K1. The first photosensitive element K1 changes its on/off state according to the first light signal, so that after the power supply device 11 is connected to the power receiving device 12, the power supply device 11 can send power supply side communication signals to the power receiving device 12.

For example, the first resistor R1 is used to divide the voltage of the first light-emitting element D1 when the first switching element Q1 is turned on, to prevent the first light-emitting element D1 from being burned out, so that the first light-emitting element D1 has a longer service life, the first primary circuit 1121 has a longer service life, and the charging system 1 further has a longer service life. Moreover, after the first switching element Q1 is controlled to turn on, the voltage drop between the input terminal and output terminal of the first switching element Q1 is relatively low, and the voltage drop between the positive electrode and negative electrode of the first light-emitting element D1 is also relatively low. Therefore, the first resistor R1 can be used to prevent a short circuit between the power supply terminal and ground terminal of the power supply side controller U1, thereby reducing the probability of damage to the power supply side controller U1 and enabling the charging system 1 to have a longer service life.

For example, the power supply side communication signals may be pulse width modulation signals (PWM), and the first switching element Q1 may be at least one of a bipolar junction transistor (BJT), a metal oxide semiconductor (MOS) field-effect transistor, an insulated gate bipolar transistor (IGBT), and an electromagnetic relay. In the present application, the specific forms of the power supply side communication signals and the first switching element Q1 are not limited.

As shown in FIG. 1 and FIG. 2, in a specific example, the first switching element Q1 may be a field-effect transistor. The short response time of the field-effect transistor makes the response of the first primary circuit 1121 more sensitive, thereby reducing the response time of the first primary circuit 1121, to improve the response speed of the entire charging system 1.

As shown in FIG. 2, for example, in a specific example, the first switching element Q1 may be an N metal oxide semiconductor (NMOS) transistor. The controlled terminal of the first switching element Q1 is a gate of the NMOS transistor, the input terminal of the first switching element Q1 is a drain of the NMOS transistor, and the output terminal of the first switching element Q1 is a source of the NMOS transistor. The signal output terminal of the power supply side controller U1 controls the gate of the NMOS transistor to switch the drain and source of the NMOS transistor between on and off, so that the first light-emitting element D1 can emit the power supply side communication signals. Understandably, the first switching element Q1 may also be a P metal oxide semiconductor (PMOS) transistor. Details will not be repeated here.

As shown in FIG. 1 and FIG. 2, in a specific example, the first primary circuit 1121 further includes a second resistor R2, a first terminal of the second resistor R2 is connected to the controlled terminal of the first switching element Q1, and a second terminal of the second resistor R2 is connected to the output terminal of the first switching element Q1, so that there is a voltage difference between the controlled terminal and output terminal of the first switching element Q1, facilitating the conduction of the first switching element Q1.

As shown in FIG. 1 and FIG. 2, in a specific example, the first primary circuit 1121 further includes a third resistor R3, a first terminal of the third resistor R3 is connected to the positive electrode of the first light-emitting element D1, and a second terminal of the third resistor R3 is connected to the negative electrode of the first light-emitting element D1. The third resistor R3 is connected in parallel to the first light-emitting element D1, so that when the first switching element Q1 is turned on, the third resistor R3 stabilizes the voltage across the first light-emitting element D1, thereby stabilizing the light emission of the first light-emitting element D1, to improve the stability of light signal transmission between the first light-emitting element D1 and the first photosensitive element K1.

As shown in FIG. 1 and FIG. 2, in a specific example, the power receiving side communication circuit 123 includes a seventh resistor R7, an eighth resistor R8, and a third switching element Q3, where a first terminal of the seventh resistor R7 is connected to a power supply terminal of the power receiving side controller U2, and a second terminal of the seventh resistor R7 is connected to the power receiving side signal receiving terminal 121B; a first terminal of the eighth resistor R8 is connected to the first terminal of the seventh resistor R7; and an input terminal of the third switching element Q3 is connected to a second terminal of the eighth resistor R8, an output terminal of the third switching element Q3 is grounded, a controlled terminal of the third switching element Q3 is connected to the second terminal of the seventh resistor R7, and the input terminal of the third switching element Q3 is connected to a signal input terminal of the power receiving side controller U2.

In an example, after the power supply device 11 is connected to the power receiving device 12, the power receiving side signal receiving terminal 121B is connected to the power supply side signal sending terminal 111A, so that the first photosensitive element K1 is connected to the power supply terminal of the power receiving side controller U2 via the seventh resistor R7, the power supply terminal of the power receiving side controller U2 can supply power to the first photosensitive element K1, and the first photosensitive element K1 switches between on and off according to the first light signal of the first light-emitting element D1, thereby achieving signal transmission from the power supply device 11 to the power receiving device 12.

When the first light-emitting element D1 does not emit light, the first photosensitive element K1 is turned off, and the third switching element Q3 is turned on, so that the signal input terminal of the power receiving side controller U2 can receive low-level signals; and when the first light-emitting element D1 emits light, the first photosensitive element K1 is turned on, and the third switching element Q3 is turned off, so that the signal input terminal of the power receiving side controller U2 can receive low-level signals, thereby enabling the power supply device 11 to send power supply side communication signals to the power receiving device 12.

When the first photosensitive element K1 is turned on, the voltage drop between the positive electrode and negative electrode of the first photosensitive element K1 is relatively low, and the use of the seventh resistor R7 can prevent a short circuit between the power supply terminal and ground terminal of the power receiving side controller U2, to reduce the probability of damage to the power receiving side controller U2; and when the third switching element Q3 is turned on, the voltage drop between the input terminal and output terminal of the third switching element Q3 is relatively low, and the use of the eighth resistor R8 can prevent a short circuit between the power supply terminal and ground terminal of the power receiving side controller U2, thereby reducing the probability of damage to the power receiving side controller U2 and enabling the charging system 1 to have a longer service life.

For example, the third switching element Q3 may be at least one of a transistor, a field-effect transistor, an insulated gate bipolar transistor, and an electromagnetic relay. In the examples of the present application, the specific form of the third switching element Q3 is not limited.

As shown in FIG. 1 and FIG. 2, in a specific example, the third switching element Q3 may be a field-effect transistor. The short response time of the field-effect transistor makes the response of the power receiving communication circuit 123 more sensitive, thereby reducing the response time of the power receiving communication circuit 123, to improve the response speed of the entire charging system 1.

As shown in FIG. 2, for example, the third switching element Q3 may be an NMOS transistor. The controlled terminal of the third switching element Q3 is a gate of the NMOS transistor, the input terminal of the third switching element Q3 is a drain of the NMOS transistor, and the output terminal of the third switching element Q3 is a source of the NMOS transistor. When the first photosensitive element K1 is turned off, the gate of the NMOS transistor is at a high level, so that the drain and source of the NMOS transistor are turned on, and the signal input terminal of the power receiving side controller U2 receives low-level signals. When the first photosensitive element K1 is turned on, the gate of the NMOS transistor is at a low level, so that the drain and source of the NMOS transistor are turned off, and the signal input terminal of the power receiving side controller U2 receives high-level signals. Understandably, the third switching element Q3 may alternatively be a PMOS transistor. Details will not be repeated here.

As shown in FIG. 2, the power receiving side communication circuit 123 further includes a ninth resistor R9, a first terminal of the ninth resistor R9 is connected to the controlled terminal of the third switching element Q3, and a second terminal of the ninth resistor R9 is connected to the output terminal of the third switching element Q3, so that there is a voltage difference between the controlled terminal and output terminal of the third switching element Q3, facilitating the conduction of the third switching element Q3.

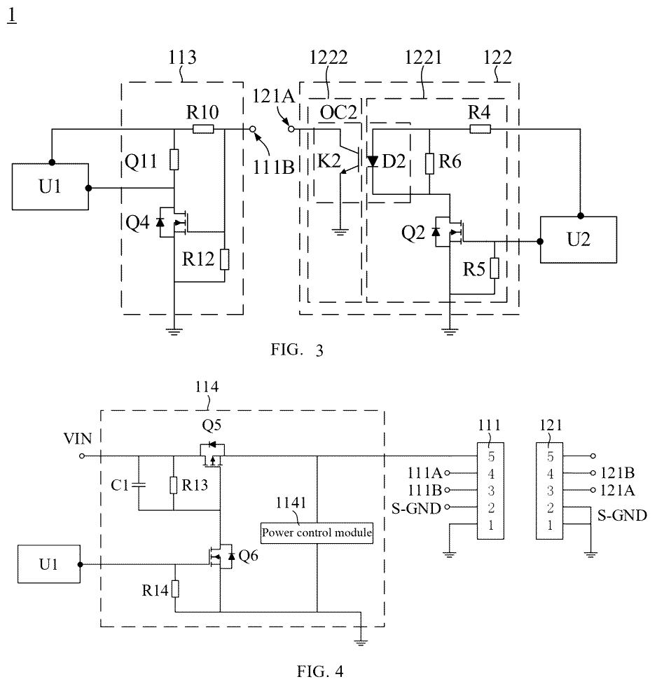

As shown in FIG. 1 and FIG. 3, in a specific example, the power receiving device 12 further includes a power receiving side optocoupler circuit 122, where the power receiving side optocoupler circuit 122 is connected to the power receiving side controller U2. The power receiving side connector 121 has a power receiving side signal sending terminal 121A connected to the power receiving side optocoupler circuit 122. And correspondingly, the power supply device 11 includes a power supply side communication circuit 113, where the power supply side communication circuit 113 is connected to the power supply side signal receiving terminal 111B of the power supply side controller U1. When the power receiving device 12 is connected to the power supply device 11 so that the power receiving side connector 121 is correspondingly connected to the power supply side connector 111, the power receiving side signal sending terminal 121A is connected to the power supply side signal receiving terminal 111B, and the power receiving side controller U2 controls the power receiving side signal sending terminal 121A to feedback power receiving side communication signals via the power receiving side optocoupler circuit 122 based on the power supply side communication signals, thereby achieving communication between the power supply device 11 and the power receiving device 12.

As shown in FIG. 1 and FIG. 3, in a specific example, the power receiving side optocoupler circuit 122 includes a second primary circuit 1221 and a second secondary circuit 1222, where the second primary circuit 1221 includes a second light-emitting element D2, and the second light-emitting element D2 is controlled by the power receiving side controller U2; and the second secondary circuit 1222 includes a second photosensitive element K2, the second photosensitive element K2 corresponds to the second light-emitting element D2, a positive electrode of the second photosensitive element K2 is connected to the power receiving side signal sending terminal 121A, and a negative electrode of the second photosensitive element K2 is connected to a ground terminal of the power receiving side connector 121. The second light-emitting element D2 and the second photosensitive element K2 form a second optocoupler OC2. There is no physical connection between the second light-emitting element D2 and the second photosensitive element K2, so that electrical signals on one side of the second photosensitive element K2 will not be transmitted to the other side of the second light-emitting element D2. Therefore, the second optocoupler OC2 is connected to the power receiving side controller U2 and the power receiving side signal sending terminal 121A in a form of photoelectric isolation, to prevent static electricity or peak voltage from entering the power receiving side controller U2 from the power receiving side signal sending terminal 121A, thereby reducing the probability of damage to the power receiving side controller U2, enabling the power receiving side controller U2 to have a longer service life, and further enabling the power receiving device 12 to have a longer service life.

Understandably, the second light-emitting element D2 may be a light-emitting diode, and the second photosensitive element K2 may be at least one of a photodiode, a photosensitive transistor, a photosensitive resistor, or a thyristor. In the present application, the specific forms of the second light-emitting element D2 and the second photosensitive element K2 are not limited.

As shown in FIG. 1 and FIG. 3, in a specific example, the second primary circuit 1221 further includes a fourth resistor R4 and a second switching element Q2, where a first terminal of the fourth resistor R4 is connected to the power supply terminal of the power receiving side controller U2, and a second terminal of the fourth resistor R4 is connected to a positive electrode of the second light-emitting element D2; and an input terminal of the second switching element Q2 is connected to a negative electrode of the second light-emitting element D2, an output terminal of the second switching element Q2 is grounded, and a controlled terminal of the second switching element Q2 is connected to a signal output terminal of the power receiving side controller U2.

After the power receiving device 12 receives the power supply side communication signals sent by the power supply device 11, the signal output terminal of the power receiving side controller U2 controls the second primary circuit 1221, so that the second light-emitting element D2 sends a second light signal to the second photosensitive element K2, the second photosensitive element K2 changes its on/off state according to the second light signal, and the power receiving device 12 sends power receiving side communication signals to the power supply device 11.

Specifically, the fourth resistor R4 is used to divide the voltage of the second light-emitting element D2 when the second switching element Q2 is turned on, to prevent the second light-emitting element D2 from being burned out, so that the second light-emitting element D2 has a longer service life, the second primary circuit 1221 has a longer service life, and the charging system 1 further has a longer service life. Moreover, after the second switching element Q2 is controlled to turn on, the voltage drop between the input terminal and output terminal of the second switching element Q2 is relatively low, and the voltage drop between the positive electrode and negative electrode of the second light-emitting element D2 is also relatively low. Therefore, the fourth resistor R4 can be used to prevent a short circuit between the power receiving terminal and ground terminal of the power receiving side controller U2, thereby reducing the probability of damage to the power receiving side controller U2 and enabling the charging system 1 to have a longer service life.

For example, the power receiving side communication signals may be pulse width modulation signals, and the second switching element Q2 may be at least one of a transistor, a field-effect transistor, an insulated gate bipolar transistor, and an electromagnetic relay. In the examples of the present application, the specific forms of the power receiving side communication signals and the second switching element Q2 are not limited.

As shown in FIG. 1 and FIG. 3, in a specific example, the second switching element Q2 may be a field-effect transistor. The short response time of the field-effect transistor makes the response of the second primary circuit 1221 more sensitive, thereby reducing the response time of the second primary circuit 1221, to improve the response speed of the entire charging system 1.

As shown in FIG. 1 and FIG. 3, for example, in a specific example, the second switching element Q2 may be an N metal oxide semiconductor (NMOS) transistor. The controlled terminal of the second switching element Q2 is a gate of the NMOS transistor, the input terminal of the second switching element Q2 is a drain of the NMOS transistor, and the output terminal of the second switching element Q2 is a source of the NMOS transistor. The signal output terminal of the power receiving side controller U2 controls the gate of the NMOS transistor to switch the drain and source of the NMOS transistor between on and off, so that the first light-emitting element D2 can emit the power receiving side communication signals. Understandably, the second switching element Q2 may alternatively be a P metal oxide semiconductor (PMOS) transistor. Details will not be repeated here.

As shown in FIG. 1 and FIG. 3, the second primary circuit 1221 further includes a fifth resistor R5, a first terminal of the fifth resistor R5 is connected to the controlled terminal of the second switching element Q2, and a second terminal of the fifth resistor R5 is connected to the output terminal of the second switching element Q2, so that there is a voltage difference between the controlled terminal and output terminal of the second switching element Q2, facilitating the conduction of the second switching element Q2.

As shown in FIG. 1 and FIG. 3, in a specific example, the second primary circuit 1221 further includes a sixth resistor R6, a first terminal of the sixth resistor R6 is connected to the positive electrode of the second light-emitting element D2, and a second terminal of the sixth resistor R6 is connected to the negative electrode of the second light-emitting element D2. The sixth resistor R6 is connected in parallel to the second light-emitting element D2, to stabilize the voltage across the second light-emitting element D2 when the second switching element Q2 is turned on, thereby stabilizing the light emission of the second light-emitting element D2, to improve the stability of light signal transmission between the second light-emitting element D2 and the second photosensitive element K2.

As shown in FIG. 1 and FIG. 3, in a specific example, the power supply side communication circuit 113 includes a tenth resistor R10, an eleventh resistor R11, and a fourth switching element Q4, where a first terminal of the tenth resistor R10 is connected to the power supply terminal of the power supply side controller U1, and a second terminal of the tenth resistor R10 is connected to the power supply side signal receiving terminal 111B. A first terminal of the eleventh resistor R11 is connected to the first terminal of the tenth resistor R10. An input terminal of the fourth switching element Q4 is connected to a second terminal of the eleventh resistor R11, an output terminal of the fourth switching element Q4 is grounded, a controlled terminal of the fourth switching element Q4 is connected to the second terminal of the tenth resistor R10, and the input terminal of the fourth switching element Q4 is connected to a signal input terminal of the power supply side controller U1.

In an example, after the power supply device 11 is connected to the power receiving device 12, the power supply side signal receiving terminal 111B is connected to the power receiving side signal sending terminal 121A, so that the second photosensitive element K2 is connected to the power receiving terminal of the power supply side controller U1 via the tenth resistor R10, the power receiving terminal of the power supply side controller U1 can supply power to the second photosensitive element K2, and the second photosensitive element K2 can switch between on and off according to the second light signal of the second light-emitting element D2, thereby achieving signal transmission from the power receiving device 12 to the power supply device 11.

When the second light-emitting element D2 does not emit light, the second photosensitive element K2 is turned off, and the fourth switching element Q4 is turned on, so that the signal input terminal of the power supply side controller U1 can receive low-level signals; and when the second light-emitting element D2 emits light, the second photosensitive element K2 is turned on, and the fourth switching element Q4 is turned off, so that the signal input terminal of the power supply side controller U1 can receive low-level signals, thereby enabling the power receiving device 12 to send power receiving side communication signals to the power supply device 11.

When the second photosensitive element K2 is turned on, the voltage drop between the positive electrode and negative electrode of the second photosensitive element K2 is relatively low, and the use of the tenth resistor R10 can prevent a short circuit between the power receiving terminal and ground terminal of the power supply side controller U1, to reduce the probability of damage to the power supply side controller U1; and when the fourth switching element Q4 is turned on, the voltage drop between the input terminal and output terminal of the fourth switching element Q4 is relatively low, and the use of the eleventh resistor R11 can prevent a short circuit between the power receiving terminal and ground terminal of the power supply side controller U1, thereby reducing the probability of damage to the power supply side controller U1 and enabling the charging system 1 to have a longer service life.

For example, the fourth switching element Q4 may be at least one of a transistor, a field-effect transistor, an insulated gate bipolar transistor, and an electromagnetic relay. In the examples of the present application, the specific form of the fourth switching element Q4 is not limited.

As shown in FIG. 1 and FIG. 3, in a specific example, the fourth switching element Q4 may be a field-effect transistor. The short response time of the field-effect transistor makes the response of the power supply side communication circuit 113 more sensitive, thereby reducing the response time of the power supply side communication circuit 113, and improving the response speed of the entire charging system 1.

As shown in FIG. 3, for example, the fourth switching element Q4 may be an NMOS transistor. The controlled terminal of the fourth switching element Q4 is a gate of the NMOS transistor, the input terminal of the fourth switching element Q4 is a drain of the NMOS transistor, and the output terminal of the fourth switching element Q4 is a source of the NMOS transistor. When the second photosensitive element K2 is turned off, the gate of the NMOS transistor is at a high level, so that the drain and source of the NMOS transistor are turned on, and the signal input terminal of the power supply side controller U1 receives low-level signals. When the second photosensitive element K2 is turned on, the gate of the NMOS transistor is at a low level, so that the drain and source of the NMOS transistor are turned off, and the signal input terminal of the power supply side controller U1 receives high-level signals. Understandably, the fourth switching element Q4 may alternatively be a PMOS transistor. Details will not be repeated here.

As shown in FIG. 3, the power supply side communication circuit 113 further includes a twelfth resistor R12, a first terminal of the twelfth resistor R12 is connected to the controlled terminal of the fourth switching element Q4, and a second terminal of the twelfth resistor R12 is connected to the output terminal of the fourth switching element Q4, so that there is a voltage difference between the controlled terminal and output terminal of the fourth switching element Q4, facilitating the conduction of the fourth switching element Q4.

As shown in FIG. 1 and FIG. 4, in a specific example, the charging circuit 114 includes a fifth switching element Q5, a sixth switching element Q6, and a power control module 1141, where an input terminal of the fifth switching element Q5 is connected to a power supply, and an output terminal of the fifth switching element Q5 is connected to the power supply side connector 111. An input terminal of the sixth switching element Q6 is connected to a controlled terminal of the fifth switching element Q5, an output terminal of the sixth switching element Q6 is grounded, and a controlled terminal of the sixth switching element Q6 is connected to a control output terminal 1C; the power control module 1141 is connected to the output terminal of the fifth switching element Q5, and the power control module 1141 is used to control output power of the charging circuit 114. In the present application, the specific form of the power control module 1141 is not limited.

As shown in FIG. 1 to FIG. 4, the power supply side controller U1, after determining that the power receiving device 12 is connected to the power supply device 11, may send an enable signal to the controlled terminal of the sixth switching element Q6, so that the input terminal and output terminal of the sixth switching element Q6 are turned on, the fifth switching element Q5 is turned on, the charging circuit 114 is turned on, and the charging circuit 114 can charge the power receiving device 12.

For example, the fifth switching element Q5 and the sixth switching element Q6 may be at least one type of transistors, field-effect transistors, insulated gate bipolar transistors, and electromagnetic relays. In the present application, the specific forms of the fifth switching element Q5 and the sixth switching element Q6 are not limited.

As shown in FIG. 1 and FIG. 4, in a specific example, both the fifth switching element Q5 and the sixth switching element Q6 may be field-effect transistors. The short response time of the field-effect transistors makes the response of the charging circuit 114 more sensitive, thereby reducing the response time of the charging circuit 114, to improve the response speed of the entire charging system 1.

As shown in FIG. 4, for example, the fifth switching element Q5 may be a PMOS transistor, the controlled terminal of the fifth switching element Q5 is a gate of the PMOS transistor, the input terminal of the fifth switching element Q5 is a source of the PMOS transistor, and the output terminal of the fifth switching element Q5 is a drain of the PMOS transistor.

As shown in FIG. 4, the charging circuit 114 further includes a thirteenth resistor R13, a first terminal of the thirteenth resistor R13 is connected to the input terminal of the fifth switching element Q5, and a second terminal of the thirteenth resistor R13 is connected to the controlled terminal of the fifth switching element Q5, so that there is a voltage difference between the controlled terminal and output terminal of the fifth switching element Q5, facilitating the turn-on of the fifth switching element Q5.

As shown in FIG. 4, for example, the sixth switching element Q6 may be an NMOS transistor, the controlled terminal of the sixth switching element Q6 is a gate of the NMOS transistor, the input terminal of the sixth switching element Q6 is a drain of the NMOS transistor, and the output terminal of the sixth switching element Q6 is a source of the NMOS transistor. When the control output terminal 1C of the power supply side controller U1 sends an enable signal to the sixth switching element Q6, the sixth switching element Q6 is turned on, so that the fifth switching element Q5 is turned on, and the charging circuit 114 can charge the power receiving device 12.

As shown in FIG. 4, the charging circuit 114 further includes a fourteenth resistor R14, a first terminal of the fourteenth resistor R14 is connected to the controlled terminal of the sixth switching element Q6, and a second terminal of the fourteenth resistor R14 is connected to the output terminal of the sixth switching element Q6, so that there is a voltage difference between the controlled terminal and output terminal of the sixth switching element Q6, facilitating the turn-on of the sixth switching element Q6.

Understandably, the fifth switching element Q5 may alternatively be an NMOS transistor, and the sixth switching element Q6 may alternatively be a PMOS transistor. Details will not be repeated here.

As shown in FIG. 4, in a specific example, the charging circuit 114 further includes a first capacitor C1, a first electrode plate of the first capacitor C1 is connected to the input terminal of the fifth switching element Q5, and a second electrode plate of the first capacitor C1 is connected to the controlled terminal of the fifth switching element Q5. The first capacitor C1 can be used to filter the power supply connected to the charging circuit 114, to reduce voltage fluctuations in the charging circuit 114.

As shown in FIG. 1, in a specific example, the power supply device 11 has at least two first magnets 115, the power receiving device 12 has at least two second magnets 124, and the first magnets 115 are arranged in one-to-one correspondence with the second magnets 124. The power receiving device 12 and the power supply device 11 can be positioned by the first magnets 115 and the second magnets 124. When the first magnets 115 attract the corresponding second magnets 124, the power receiving side connector 121 is correspondingly connected to the power supply side connector 111, thereby improving alignment and connection accuracy between the power receiving side connector 121 and the power supply side connector 111, and facilitating the corresponding connection between the power receiving side connector 121 and the power supply side connector 111.

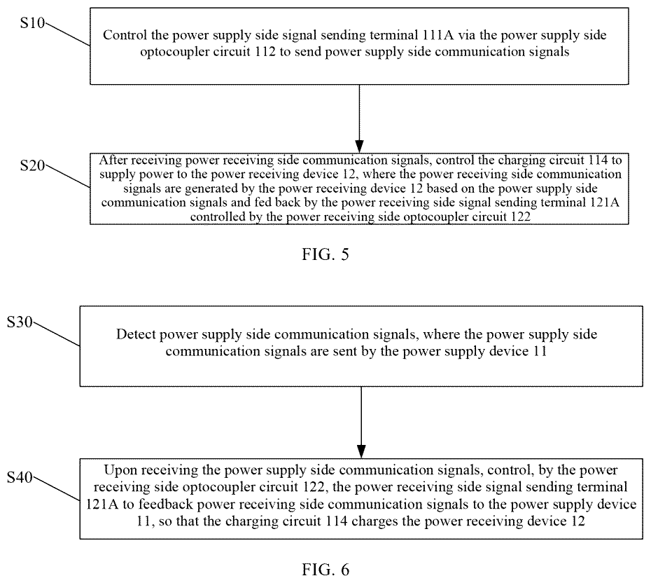

As shown in FIG. 1 to FIG. 5, an example of the present application further provides a charging control method, applied to, for example, the power supply device 11, the charging control method including:

Step S10: Control the power supply side signal sending terminal 111A via the power supply side optocoupler circuit 112 to send power supply side communication signals.

In an example of the present application, after the power supply device 11 is connected to the power receiving device 12, the power supply device 11 can control the power supply side signal sending terminal 111A via the first light-emitting element D1 and the first photosensitive element K1 to send the power supply side communication signals to the power receiving device 12.

Understandably, after the power supply device 11 is connected to the mains supply, the power supply side signal sending terminal 111A is connected to the power receiving side signal receiving terminal 121B, the signal output terminal of the power supply side controller U1 may control the first primary circuit 1121. The first light-emitting element D1 may send the first light signal to the first photosensitive element K1 in a preset duration, and the first photosensitive element K1 may change its on/off state according to the first light signal. When the power supply side connector 111 is connected to the power receiving side connector 121, the power receiving device 12 may obtain the power supply side communication signals within a relatively short time, whereby the response speed of the power receiving device 12 is improved. For example, the preset duration may be 200 ms, 250 ms, or 300 ms.

Step S20: After receiving power receiving side communication signals, control the charging circuit 114 to supply power to the power receiving device 12, where the power receiving side communication signals are generated by the power receiving device 12 based on the power supply side communication signals and fed back by the power receiving side signal sending terminal 121A controlled by the power receiving side optocoupler circuit 122.

In an example of the present application, after the power receiving device 12 receives the power supply side communication signals sent by the power supply device 11, the signal output terminal of the power receiving side controller U2 controls the second primary circuit 1221. The second light-emitting element D2 may send the second light signal to the second photosensitive element K2. The second photosensitive element K2 may change its on/off state according to the second light signal. The power receiving device 12 may feed back the power receiving side communication signals to the power supply device 11. The control output terminal of the power supply side controller U1 may send an enable signal to the controlled terminal of the fifth switching element Q5. The fifth switching element Q5 may be turned on, the sixth switching element Q6 may be turned on, and the charging circuit 114 may be turned on, so that the charging circuit 114 can supply power to the power receiving device 12.

As shown in FIG. 1 to FIG. 4 and FIG. 6, an example of the present application further provides a charging control method, applied to the power receiving device 1212, the charging control method including:

Step S30: Detect power supply side communication signals, where the power supply side communication signals are sent by the power supply device 11.

In an example of the present application, the signal input terminal of the power receiving side controller U2 detects regularly (e.g., at an interval) whether the power supply side communication signals are received.

Understandably, the signal input terminal of the power receiving side controller U2 can detect the power supply side communication signals in a preset duration, so that when the power supply side connector 111 is connected to the power receiving side connector 121, the power receiving device 12 can obtain the power supply side communication signals within a relatively short time, whereby the response speed of the power receiving device 12 is improved. For example, the preset duration may be 200 ms, 250 ms, or 300 ms.

Step S40: Upon receiving the power supply side communication signals, control, by the power receiving side optocoupler circuit 122, the power receiving side signal sending terminal 121A to feedback power receiving side communication signals to the power supply device 11, so that the charging circuit 114 charges the power receiving device 12.

In an example of the present application of the application, after the power receiving device 12 receives the power supply side communication signals sent by the power supply device 11, the signal output terminal of the power receiving side controller U2 may control the second primary circuit 1221. The second light-emitting element D2 may send the second light signal to the second photosensitive element K2. The second photosensitive element K2 may change its on/off state according to the second light signal. The power receiving device 12 may send the power receiving side communication signals to the power supply device 11. The control output terminal of the power supply side controller U1 may send an enable signal to the controlled terminal of the fifth switching element Q5. The fifth switching element Q5 may be turned on, the sixth switching element Q6 may be turned on, and the charging circuit 114 may be turned on, so that the charging circuit 114 can supply power to the power receiving device 12.

The same or similar reference numerals in the accompanying drawings of the examples correspond to the same or similar components. In the description of the present application, it should be understood that, if the terms such as “up”, “down”, “left”, and “right” indicate orientations or positional relationships based on the orientations or positional relationships shown in the accompanying drawings, the terms are only for the convenience of describing the present application and simplifying the description, and do not indicate or imply that an apparatus or component referred to must have a specific orientation or be constructed and operated in a specific orientation. Therefore, the terms for describing the positional relationships in the accompanying drawings are only for illustrative description and cannot be understood as limitations of this patent. Those of ordinary skill in the art can understand the specific meanings of the above terms according to specific situations.

Described above are merely the preferred examples of the present application, which are not used for limiting the present application. Any modification, equivalent replacement and improvement, and the like made within the spirit and principle of the present application shall fall within the protection scope of the present application.

What is claimed is:

1. A power supply device comprising:
a power supply controller;
a power supply optocoupler circuit connected to the power supply controller; and
a power supply connector comprising a terminal connected to the power supply optocoupler circuit,
wherein the power supply optocoupler circuit is configured to control the terminal to send a power supply communication signal to a power receiving device.

2. The power supply device of claim 1, wherein the power supply optocoupler circuit comprises:
a primary circuit comprising a light-emitting element controlled by the power supply controller; and
a secondary circuit comprising a photosensitive element, wherein the photosensitive element corresponds to the light-emitting element, a positive electrode of the photosensitive element is connected to the terminal, and a negative electrode of the photosensitive element is connected to a ground terminal of the power supply connector.

3. The power supply device of claim 2, wherein the primary circuit further comprises:
a resistor, wherein a first terminal of the resistor is connected to a power supply terminal of the power supply controller, and a second terminal of the resistor is connected to a positive electrode of the light-emitting element; and
a switch, wherein an input terminal of the switch is connected to a negative electrode of the light-emitting element, an output terminal of the switch is grounded, and a controlled terminal of the switch is connected to a signal output terminal of the power supply controller.

4. The power supply device of claim 3, wherein:
the switch is a field-effect transistor, the controlled terminal of the switch is a gate of the field-effect transistor, the input terminal of the switch is a drain of the field-effect transistor, and the output terminal of the switch is a source of the field-effect transistor; and
the primary circuit further comprises a second resistor, a first terminal of the second resistor is connected to the controlled terminal of the switch, and a second terminal of the second resistor is connected to the output terminal of the switch; or the primary circuit further comprises a third resistor, a first terminal of the third resistor is connected to the positive electrode of the light-emitting element, and a second terminal of the third resistor is connected to the negative electrode of the light-emitting element.

5. The power supply device of claim 1, further comprising a charging circuit connected to a power supply output terminal of the power supply connector and the power supply controller, wherein:
the power supply output terminal is configured to be connected to a power receiving input terminal of a power receiving connector in the power receiving device, and
the charging circuit is configured to charge the power receiving device.

6. The power supply device of claim 5, wherein the charging circuit comprises:
a second switch, wherein an input terminal of the second switch is configured to be connected to a power supply, and an output terminal of the second switch is connected to the power supply output terminal of the power supply connector;
a third switch, wherein an input terminal of the third switch is connected to a controlled terminal of the second switch, an output terminal of the third switch is grounded, and a controlled terminal of the third switch is connected to a control output terminal of the power supply controller; and
a power control module connected to the output terminal of the second switch.

7. The power supply device of claim 1, further comprising at least two first magnets corresponding to two second magnets of the power receiving device.

8. The power supply device of claim 1, further comprising a power supply communication circuit connected to the power supply controller, wherein the power supply communication circuit comprises:
a fourth resistor, wherein a first terminal of the fourth resistor is connected to a power supply terminal of the power supply controller;
a fifth resistor, wherein a first terminal of the fifth resistor is connected to the first terminal of the fourth resistor; and
a fourth switch, wherein an input terminal of the fourth switch is connected to a second terminal of the fifth resistor, an output terminal of the fourth switch is grounded, a controlled terminal of the fourth switch is connected to a second terminal of the fourth resistor, and an input terminal of the fourth switch is connected to a signal input terminal of the power supply controller.

9. A power receiving device comprising:
a power receiving controller;
a power receiving optocoupler circuit connected to the power receiving controller; and
a power receiving connector comprising a terminal connected to the power receiving optocoupler circuit,
wherein the power receiving optocoupler circuit is configured to control the terminal to:
receive a first communication signal from a power supply device; and
send a second communication signal to the power supply device.

10. The power receiving device of claim 9, wherein the power receiving optocoupler circuit comprises:
a primary circuit comprising a light-emitting element, wherein the light-emitting element is controlled by the power receiving controller; and
a secondary circuit comprising a photosensitive element, wherein the photosensitive element corresponds to the light-emitting element, a positive electrode of the photosensitive element is connected to the terminal, and a negative electrode of the photosensitive element is connected to a ground terminal of the power receiving connector.

11. The power receiving device of claim 10, wherein the primary circuit further comprises:
a resistor, wherein a first terminal of the resistor is connected to a power supply terminal of the power receiving controller, and a second terminal of the resistor is connected to a positive electrode of the light-emitting element; and
a switch, wherein an input terminal of the switch is connected to a negative electrode of the light-emitting element, an output terminal of the switch is grounded, and a controlled terminal of the switch is connected to a signal output terminal of the power receiving controller.

12. The power receiving device of claim 11, wherein:
the switch is a field-effect transistor, the controlled terminal of the switch is a gate of the field-effect transistor, the input terminal of the switch is a drain of the field-effect transistor, and the output terminal of the switch is a source of the field-effect transistor;
the primary circuit further comprises a second resistor, a first terminal of the second resistor is connected to the controlled terminal of the switch, and a second terminal of the second resistor is connected to the output terminal of the switch; or the primary circuit further comprises a third resistor, a first terminal of the third resistor is connected to the positive electrode of the light-emitting element, and a second terminal of the third resistor is connected to the negative electrode of the light-emitting element.

13. A charging control method for a power supply system comprising:
controlling, by a controller, a power supply terminal in a power supply device to send, via a power supply optocoupler circuit, a first communication signal;
receiving a second communication signal from a power receiving terminal of a power receiving device; and
controlling, based on the second communication signal, a charging circuit in the power supply device to supply power to the power receiving device.

14. The charging control method of claim 13, further comprising:
connecting the power supply terminal to the power receiving terminal of the power receiving device.

15. The charging control method of claim 13, wherein the controlling the charging circuit comprises sending a signal to the charging circuit to control a plurality of switches in the charging circuit.

16. The charging control method of claim 13, wherein the power supply optocoupler circuit comprises:
a primary circuit comprising a light-emitting element controlled by controller; and
a secondary circuit comprising a photosensitive element, wherein the photosensitive element corresponds to the light-emitting element.

17. The charging control method of claim 16, wherein the controlling the power supply terminal to send the first communication signal comprises controlling the power supply terminal, via the light-emitting element and the photosensitive element, to send the first communication signal.

18. The charging control method of claim 13, wherein the receiving the second communication signal is based on detecting the first communication signal.

19. The charging control method of claim 14, further comprising:
generating the first communication signal in response to the connecting power supply terminal to the power receiving terminal of the power receiving device.

20. The charging control method of claim 13, wherein the first communication signal comprises one or more pulse width modulation signals.
